(19) United States
(12) Patent Application Publication
(10) Pub. No.: US 2024/0253009 A1
(43) Pub. Date: Aug. 1, 2024

(54) ACID WASHING

(71) Applicant: CALGON CARBON CORPORATION, Moon Township, PA (US)

(72) Inventors: Jason P. MAZZOCCOLI, Pittsburgh, PA (US); Ryan W. WALKER, Pittsburgh, PA (US); Walter G. TRAMPOSCH, Moon Township, PA (US)

(73) Assignee: CALGON CARBON CORPORATION, Moon Township, PA (US)

(21) Appl. No.: 18/428,765

(22) Filed: Jan. 31, 2024

Related U.S. Application Data
(60) Provisional application No. 63/482,461, filed on Jan. 31, 2023.

(51) Int. Cl. B01J 20/20; B01J 20/02; B01J 20/30; C02F 1/28

(52) U.S. Cl. CPC B01J 20/20; B01J 20/024; B01J 20/3078; C02F 1/283; B01J 2220/4812

(57) ABSTRACT

Sorbent materials contain carbonaceous material that has been activated to form a precursor activated carbon have been subjected to a pretreatment with an acid or a base followed optionally by thermal oxidation are useful for treating water. The sorbent material is made by contacting the precursor activated carbon with a nitrogen source and a metal source, and optionally by thermally oxidizing the precursor activated carbon. The resulting doped precursor activated is also calcined.

### CROSS-REFERENCE TO RELATED APPLICATIONS

This application claims priority to U.S. Provisional Application No. 63/482,461 filed on Jan. 31, 2023, the entirety of which is incorporated herein by reference.

### FIELD

The present disclosure relates generally to activated carbon for water treatment. More specifically, the present disclosure relates to a compositions and methods of making an activated with high efficacy towards removing specific contaminants, and methods of using the same.

### BACKGROUND

The use of sorbents for water treatment is well established as an effective method to remove varied contaminants from water sources. Sorbents with different properties may be chosen to selectively remove specific contaminants, allowing a broad range of water treatment systems to be developed. Of particular interest is the removal of harmful and regulated contaminants such as chlorine, chloramine, chloroform, trihalomethanes, haloacetic acids, and peroxides, on which there are limits in municipal and drinking water sources. In addition to posing health risks, these contaminants may alter the smell or taste of drinking water and may cause corrosion and degradation of water system lines.

Previous strategies for the removal of chlorine, chloramine, chloroform, trihalomethanes, haloacetic acids, and peroxides have focused on treating activated carbon sorbent materials by way of nitrogen doping and thermal calcination to impart nitrogen-edge group functionality into the sorbent material structure, thus improving chloramine and chlorine removal performance. Chemical oxidation treatments on sorbent materials prior to nitrogen doping have also proven effective for enhancing chloramine and peroxide removal properties.

However, these methods have been focused on coal-based activated carbon feedstocks, and it is more challenging to achieve this enhanced performance with coconut- and wood-based activated carbons. Coconut-based activated carbon in particular offers the benefit of intrinsic volatile organic compound (VOC) removal. Thus, it is very desirable to combine coconut-based carbon's high VOC removal with improved chloramine, chlorine, and peroxide removal capabilities to provide a dual use sorbent material.

At the same time, it is remains desirable to not only apply the above-described techniques to coconut-based activated carbon, but also to still further improve coal-based activated carbon.

### SUMMARY

In some aspects, the techniques described herein relate to a sorbent material, including: a carbonaceous material which has been activated to form a precursor activated carbon, wherein the precursor activated carbon has been subjected to a pretreatment with an acid or a base followed by optional thermal oxidation, and wherein the precursor activated carbon has been contacted with a nitrogen source and a metal source and includes about 5% to about 12% nitrogen as measured on a dry precursor activated carbon basis and about 0.1 wt. % to about 1.0 wt. % metal as measured on a dry precursor activated carbon basis.

In some aspects, the techniques described herein relate to a sorbent material, wherein the sorbent material has a modified contact pH of about 3 to about 11.

In some aspects, the techniques described herein relate to a sorbent material, wherein the pretreatment is with an acid.

In some aspects, the techniques described herein relate to a sorbent material, wherein the acid is any of nitric acid, sulfuric acid, hydrochloric acid, hydrobromic acid, hydroiodic acid, phosphoric acid, acetic acid, citric acid, ascorbic acid, or combinations thereof.

In some aspects, the techniques described herein relate to a sorbent material, wherein the sorbent material has a modified contact pH of about 5 to about 8.

In some aspects, the techniques described herein relate to a sorbent material, wherein the pretreatment is with a base.

In some aspects, the techniques described herein relate to a sorbent material, wherein the base is any of sodium hydroxide, ammonium hydroxide, magnesium hydroxide, potassium hydroxide, calcium hydroxide, ammonia, sodium carbonate, sodium bicarbonate, or combinations thereof.

In some aspects, the techniques described herein relate to a sorbent material, wherein the sorbent material has a modified contact pH of about 7 to about 11.

In some aspects, the techniques described herein relate to a sorbent material, wherein the metal is selected from iron, copper, zinc, or combinations thereof.

In some aspects, the techniques described herein relate to a sorbent material, wherein the carbonaceous material is formed from one or more of coconut shell, bituminous coal, sub-bituminous coal, lignite coal, or anthracite coal.

In some aspects, the techniques described herein relate to a sorbent material, wherein the sorbent material has a chloramine destruction number (CDN) of about 10 to about 75.

In some aspects, the techniques described herein relate to a sorbent material, wherein the sorbent material has a chloramine destruction number (CDN) of about 37 to about 72.

In some aspects, the techniques described herein relate to a sorbent material, wherein the sorbent material has a peroxide number of about 1.5 minutes to about 40 minutes.

In some aspects, the techniques described herein relate to a sorbent material, wherein the sorbent material has a peroxide number of about 2.6 minutes to about 3.7 minutes.

In some aspects, the techniques described herein relate to a sorbent material, wherein the sorbent material has an oxygen content of about 3% to about 9%.

In some aspects, the techniques described herein relate to a method for making a sorbent material, including steps of: providing a carbonaceous material, activating the carbonaceous material to form a precursor activated carbon, pretreating the precursor activated carbon with an acid or a base, optionally thermally oxidizing the precursor activated carbon at a temperature of about 450° C., contacting the precursor activated carbon with a metal source and a nitrogen source to form a doped precursor activated carbon, and calcining the doped precursor activated carbon at a temperature of about 950° C.

In some aspects, the techniques described herein relate to a method, wherein the carbonaceous material is formed from one or more of coconut shell, bituminous coal, sub-bituminous coal, lignite coal, or anthracite coal.

In some aspects, the techniques described herein relate to a method, wherein the acid is any of nitric acid, sulfuric acid, hydrochloric acid, hydrobromic acid, hydroiodic acid, phosphoric acid, acetic acid, citric acid, ascorbic acid, or combinations thereof.

In some aspects, the techniques described herein relate to a method, wherein the base is any of ammonium hydroxide, sodium hydroxide, magnesium hydroxide, potassium hydroxide, calcium hydroxide, ammonia, sodium carbonate, sodium bicarbonate, or combinations thereof.

In some aspects, the techniques described herein relate to a method, wherein the metal source is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, zinc chloride, zinc nitrate, zinc sulfate, zinc acetate, hydrates thereof, or combinations thereof.

In some aspects, the techniques described herein relate to a method, wherein the nitrogen source has an oxidation state of −3.

In some aspects, the techniques described herein relate to a method, wherein the nitrogen source includes urea, dicyandiamide, melamine, or combinations thereof.

In some aspects, the techniques described herein relate to a method, wherein the sorbent material has a modified contact pH of about 5 to about 11.

In some aspects, the techniques described herein relate to a method, wherein the sorbent material has a chloramine destruction number (CDN) of about 10 to about 75.

In some aspects, the techniques described herein relate to a sorbent material, wherein the sorbent material has a chloramine destruction number (CDN) of about 37 to about 72.

In some aspects, the techniques described herein relate to a method, wherein the sorbent material has a peroxide number of about 1.5 minutes to about 40 minutes.

In some aspects, the techniques described herein relate to a method, wherein the sorbent material has a peroxide number of about 2.6 minutes to about 3.7 minutes.

In some aspects, the techniques described herein relate to a method, wherein the sorbent material has an oxygen of about 3% to about 9%.

In some aspects, the techniques described herein relate to a method for treating water that potentially contains chlorine, chloramine, chloroform, trihalomethanes, haloacetic acids, peroxides, volatile organic compounds, or combinations thereof, including steps of: contacting the water with a sorbent material which includes an activated carbon formed from a carbonaceous material and wherein the activated carbon has been pretreated with an acid or a base and subsequent thermal oxidation, followed by doping with a metal source and a nitrogen source, wherein contacting the water with sorbent material results in removal of one or more of chlorine, chloramine, chloroform, trihalomethanes, haloacetic acids, peroxides, and volatile organic compounds.

In some aspects, the techniques described herein relate to a method, wherein the carbonaceous material is one or more of bituminous coal, sub-bituminous coal, lignite coal, anthracite coal, or coconut shell.

In some aspects, the techniques described herein relate to a method, wherein the metal source is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, zinc chloride, zinc nitrate, zinc sulfate, zinc acetate, hydrates thereof, or combinations thereof.

In some aspects, the techniques described herein relate to a method, wherein the nitrogen source has an oxidation state of −3.

In some aspects, the techniques described herein relate to a method, wherein the nitrogen source includes urea, dicyandiamide, melamine, or combinations thereof.

In some aspects, the techniques described herein relate to a method, wherein the sorbent material has a modified contact pH of about 3 to about 11.

In some aspects, the techniques described herein relate to a method, wherein the sorbent material has a chloramine destruction number (CDN) of about 10 to about 75.

In some aspects, the techniques described herein relate to a method, wherein the sorbent material has a chloramine destruction number (CDN) of about 37 to about 72.

In some aspects, the techniques described herein relate to a method, wherein the sorbent material has a peroxide number of about 1.5 minutes to about 40 minutes.

In some aspects, the techniques described herein relate to a method, wherein the sorbent material has a peroxide number of about 2.6 minutes to about 3.7 minutes.

In some aspects, the techniques described herein relate to a method, wherein the sorbent material has an oxygen content of about 3% to about 9%.

### DRAWINGS

Aspects, features, benefits, and advantages of the embodiments described herein will be apparent with regard to the following description, appended claims, and accompanying drawings where:

FIG. 1 is a graph showing the relationship between modified contact pH with the resulting chloramine destruction number (CDN) and the peroxide number in activated carbon doped with copper-iron and urea.

FIG. 2 is a graph showing the relationship between modified contact pH with the resulting chloramine destruction number (CDN) and the peroxide number in activated carbon doped with iron and urea.

FIG. 3 is a graph showing the relationship between modified contact pH with the resulting chloramine destruction number (CDN) and the peroxide number in activated carbon doped with copper and urea.

FIG. 4 is a graph of ash level versus modified contact pH, showing that modified contact pH of the activated carbon and the ash level are not well-correlated.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

As used herein, the term “sorbent material” means any material that exhibits adsorbent properties, absorbent properties, or a combination of adsorbent properties and absorbent properties. Adsorbent properties mean that atoms, ions, or molecules adhere to the surface of the material. Absorbent properties means that atoms, ions, or molecule enter and are retained by a bulk phase of the material. By way of example, sorbent materials include but are not limited to activated carbon, reactivated carbon, natural and synthetic zeolite, silica, silica gel, alumina, zirconia, and diatomaceous earths. As used herein, “sorbent material” is a material whose constituent components are substantially adsorbent and/or absorbent, with only minimal components that are not adsorbent and/or absorbent (for example, the minimal amount of binder that is required for activated carbon pellets to maintain their shape).

As used herein, the term “sorbent” means any composition or composite that includes a sorbent material in a blend, mixture, composite, or compound with one or more additional materials that do not exhibit adsorbent properties. By way of example, one embodiment of sorbent includes an activated carbon sorbent material mixed with a thermally conductive filler.

As used herein, the term “carbonaceous material” means a material that contains carbon that has not been thermally activated or chemically activated. Carbonaceous material may have been mechanically treated, thermally treated, or chemically treated, and can even have weakly sorbent properties, but carbonaceous material does not adsorb compounds in substantial amounts as would be expected of a material such as activated carbon. Examples of carbonaceous material include but are not limited to bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

As used herein, the term “macropores” means pores within a sorbent that are greater than about 50 nm in diameter.

As used herein, the term “mesopores” means pores within a sorbent that have a diameter of about 2 nm to about 50 nm.

As used herein, the term “micropores” means pores within a sorbent that have a diameter of less than about 2 nm.

As used herein, “chloramine” means one or more of mono-chloramine (NH₂Cl), di-chloramine (NHCl₂), or tri-chloramine (NCl₃).

The sorbents or sorbent materials described herein are useful for removing chloroforms and other similar volatile organic chemical compounds (VOC) from fluids such as water. The VOC are not limited and include one or more of styrene, alachlor, atrazine, benzene, carbofuran, carbon tetrachloride, chlorobenzene, chloropicrin, 2,4-dichlorophenoxyacetic acid (2,4-D), dibromochloropropane (DBCP), o-dichlorobenzene, p-dichlorobenzene, 1,2-dichloroethane, 1,1-dichloroethylene, cis-1,2-dichloroethylene, trans-1,2-dichloroethylene, 1,2-dichloropropane, cis-1,3-dichloropropylene, dinoscb, endrin, ethylbenzene, ethylene dibromide (EDB), haloacetonitriles (HAN) including bromochloroacetonitrile, dibromoacetonitrile, dichloroacetonitrile, and trichloroacetonitrile, haloketones (HK) including 1,1-dichloro-2-propanone and 1,1,1-trichloro-2-propanone, heptachlor (H-34, Heptox), heptachlor epoxide, hexachlorobutadiene, hexachlorocyclopentadiene, lindane, methoxychlor, pentachlorophenol, simazine, styrene, 1,1,2,2-tetrachloroethane, tetrachloroethylene, toluene, 2,4,5-TP (silvex), tribromoacetic acid, 1,2,4-trichlorobenzene, 1,1,1-trichlorocthane, 1,1,2-trichloroethane, trichloroethylene, trihalomethanes including chloroform, bromoform, bromodichloromethane, chlorodibromomethane, or xylene. VOC that are relevant in the field of drinking water are known in the industry and are described, for example, in NSF/ANSI 53-2019, which was designated a standard on May 6, 2019, and which is incorporated by reference in its entirety. In some instances, the removal of VOC by sorbents or sorbent materials is measured by the removal of the individual VOC species themselves. In other embodiments, the removal of VOC by sorbents or sorbent materials is measured by the removal of surrogate compounds. Surrogates are compounds that are similar in chemical composition to the analytes of interest, and which are present in sample prior to preparation and analysis. For example, chloroform is one example of a surrogate for the compounds of this paragraph.

This disclosure describes examples of treatments for sorbent materials that yield unique contaminant removal properties. Specifically, the sorbent materials are activated carbons formed from various precursors which are treated with various treatment methods to improve their contaminant removal performance.

The present disclosure describes methods for preparing a sorbent material including treating activated carbon with acid or base followed by an optional thermal oxidation followed by metal and nitrogen doping in order to improve chloramine, chlorine, and peroxide removal properties. Without wishing to be bound by theory, the disclosed methods are particularly advantageous for use with coconut- and wood-based activated carbons, instead of the coal-based activated carbons that previous methods are directed towards.

According to some embodiments of the present disclosure, one or more carbonaceous materials are provided and activated by any suitable technique to yield a precursor activated carbon. The precursor activated carbon is then washed with an acid or a base to yield a washed activated carbon. The washed activated carbon is then optionally thermally treated to yield a pre-doped precursor activated carbon. In some embodiments, thermally treating may include drying, thermal oxidation, or combinations thereof. The pre-doped precursor activated carbon is then subjected to doping with metals and nitrogen to yield a doped precursor activated carbon, which is subsequently calcined to yield a metal and nitrogen doped activated carbon according to the disclosure herein.

Prior disclosures that describe methods of doping a precursor activated carbon include U.S. Pat. No. 10,702,853, U.S. Provisional Application Ser. No. 63/072,531 entitled “Copper and Nitrogen Treated Sorbent and Method for Making the Same”; U.S. Patent Application Pub. No. 2022/0062861 claiming priority to U.S. Provisional Application Ser. No. 63/072,544 entitled “Copper, Iron, and Nitrogen Treated Sorbent and Method for Making the Same”, U.S. Patent Application Pub. No. 2022/0062855 which claims priority to U.S. Provisional Application Ser. No. 63/072,514 entitled “Iron and Nitrogen Treated Sorbent and Method for Making Same”, each of which is incorporated by reference herein in their entirety. The present disclosure demonstrates that acid/base washing an activated carbon and an optional thermal treatment of the acid/base washed activated carbon prior to doping with metal/nitrogen yields a doped activated carbon having improved chloramine, chlorine, and peroxide removal properties. This disclosed treatment is particularly useful with coconut shell based activated carbons because it has been challenging to impart coconut shell based activated carbon with chloramine destruction properties by way of conventional treatment techniques.

It has been previously reported that it is possible to use metal-nitrogen doping of coconut-based activated carbons to enhance chloramine destruction performance. The present disclosure provides methods of pretreating activated carbons, such as but not limited to coconut-based or coal-based activated carbons, to enhance chloramine and peroxide destruction performance further by first washing a precursor activated carbon with an acid or a base to yield a washed precursor activated carbon, and then, optionally, thermally oxidizing the washed precursor activated carbon. Following the washing and optional thermal oxidation steps with metal-nitrogen doping to provide a doped activated carbon results in improved chloramine, chlorine, and peroxide removal properties relative to untreated activated carbon. It has also been demonstrated herein that further improvement is seen when the acid or base washing step is conducted first and thermal oxidation second. When both are employed, in that order, the resultant sorbent material has excellent performance properties. Altering the virgin coconut activated carbon or virgin coal activated carbon's modified contact pH and oxygen concentration through pretreatment allows for the most effective chloramine and peroxide destruction performance to realized.

There are provided one or more carbonaceous materials that are precursors to final sorbents. These carbonaceous materials may have been mechanically, thermally, or chemically treated prior to activation to produce activated carbon. As will be understood by those skilled in the art, activated carbon may be formed from numerous carbonaceous materials, including but not limited to bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, and polymer fibers. Each of these materials may impart different properties on the resulting sorbent material, and thus it may be advantageous to select an activated carbon formed from a particular carbonaceous material depending on the purpose for which the activated carbon will be used.

In some embodiments, the carbonaceous material is coconut shell. Coconut shell carbonaceous materials are particularly useful because when coconut shell is activated to form activated carbon, it exhibits excellent adsorption of chloroform and other organic compounds relative to activated carbons formed from other starting materials. Coconut-based activated carbon offers a high degree of intrinsic VOC removal relative to coal-based carbons because of a well-developed micropore structure. Using treatment methods to improve a particular performance on a coconut-based activated carbon allows one to take advantage of both the intrinsic properties of coconut carbon along with the benefits of the particular treatment method. Such a “dual use” carbon may be especially useful in applications where the removal of multiple contaminants is desired.

In some other embodiments, the carbonaceous material is coal. The coal is not limited and includes one or more of bituminous coal, sub-bituminous coal, lignite coal, or anthracite coal.

After the carbonaceous material is provided, it is activated. The method used to activate the carbon prior to performing the method of the present disclosure is not particularly limited. In some embodiments, the carbonaceous material may be activated by thermal methods; in some embodiments, the carbonaceous material may be activated by chemical methods. Activation processes depend on the type of carbonaceous material utilized and the desired form the final activated carbon. Activation steps may include one or more of pyrolysis of the carbonaceous material to form a charcoal, pulverizing the charcoal, mixing a binder with the pulverized charcoal, briquetting the pulverized charcoal and binder, crushing the briquettes, sizing the crushed briquettes, and baking the sized briquettes or the briquettes themselves to carbonize, cure, or remove the binder. However, in all instances, the carbonaceous material in any form is thermally activated, chemically activated, or thermally and chemically activated. Thermal activation is performed by heating the baked briquettes or sized particles in the presence of one or more of water, oxygen, and carbon dioxide. Chemical activation is performed by impregnating the baked briquettes or sized particles in the presence of a strong acid, strong base, or a salt. It should be noted that whether each of the above steps are included in the processing sometimes depends on the provided carbonaceous material. For example, when the carbonaceous material is coconut, process steps do not include “reagglomeration,” which is the steps of mixing a binder with the pulverized charcoal, briquetting the pulverized charcoal and binder, crushing the briquettes, and sizing the crushed briquettes. In some embodiments of the present disclosure, activating the carbonaceous material provides a precursor activated carbon.

The precursor activated carbon is then treated according to embodiments of the present disclosure. In some embodiments, pretreating the precursor activated carbon may include washing the precursor activated carbon with acid or base, thermally treating the precursor activated carbon, and/or doping the precursor activated carbon with a metal and nitrogen. In some embodiments, the pretreatment steps may be carried out in the order of washing, thermally treating, and doping. In some embodiments, the steps may be carried out in the order of thermally treating, washing, and doping. In some embodiments, the step of washing may be omitted, such that the method may include the steps of thermally treating and doping. In some embodiments, the step of thermally treating is omitted, such that the method may include the steps of washing and doping. It was found that conducting the treatment steps in the order of washing, thermally treating, and doping resulted in performance improvements over conducting the treatment steps in another order. In the above embodiments, thermal treatment of the precursor activated carbon may include drying steps, thermal oxidation, or combinations thereof.

In some embodiments, the step of washing may be conducted with hydrochloric acid, sulfuric acid, nitric acid, citric acid, ascorbic acid, ammonium hydroxide, sodium hydroxide, magnesium hydroxide, potassium hydroxide, calcium hydroxide, ammonia, sodium carbonate, or sodium bicarbonate, or combinations thereof. The precursor activated carbon can be washed in a solution of acid or base with a concentration of about 0.1 M to about 0.5 M, for example about 0.1 M, about 0.2 M, about 0.3 M, about 0.4 M, about 0.5 M, or within a range between any two such values, for time of about 1 hour, about 2 hours, about 3 hours, about 4 hours, about 5 hours, or within a range between any two such values. The washing step may include stirring and/or subsequent washing of the precursor activated carbon with water. In some embodiments, the washing step may be carried out before any other step of the method of the present disclosure. In some embodiments, the washing step may be carried out after any other step of the method of the present disclosure.

In some embodiments, the thermal treatment step may be carried out at about 300° C. to about 600° C., for example about 300° C., about 350° C., about 400° C., about 450° C., about 500° C., about 550° C., about 600° C., or within a range between any two such values. The time of the thermal treatment step may be about 10 minutes, about 20 minutes, 30 minutes, about 1 hour, about 2 hours, or any value or range between any two such values. In some embodiments, the thermal treatment step may be carried out after the washing step. In some embodiments, the thermal treatment step may be carried out before the washing step. In some embodiments, the thermal treatment step may be omitted. In some embodiments, the thermal treatment step includes drying, thermally oxidizing, or combinations thereof.

In some embodiments, the doping step may include impregnating the washed and/or thermally treated activated carbon with a metal and a nitrogen source. The doping step may include contacting the washed and/or thermally treated activated carbon with an aqueous solution of a metal salt and a nitrogen-containing compound. In some embodiments, the metal salt is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, zinc chloride, zinc nitrate, zinc sulfate, zinc acetate, hydrates thereof, or combinations thereof. In some embodiments, the nitrogen-containing compound is urea, dicyandiamide, melamine, or other nitrogen-containing compounds having an oxidation state of −3. Contacting the washed and/or thermally treated activated carbon with the metal and nitrogen solution may form a doped activated carbon. After contacting, the doped activated carbon may be dried in air or under an inert atmosphere at a temperature above room temperature. In some embodiments, the doped activated carbon is dried at a temperature of about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., or within a range between any two such values.

The doped activated carbon may be evaluated in terms of metal loading on a dry carbon basis. In some embodiments, the metal loading may be about 0.10 wt. %, about 0.15 wt. %, 0.20 wt. %, about 0.25 wt. %, about 0.30 wt. %, about 0.35 wt. %, about 0.40 wt. 9%, about 0.45 wt. %, about 0.50 wt. %, about 0.55 wt. %, about 0.60 wt. %, about 0.65 wt. %, about 0.70 wt. %, about 0.75 wt. %, about 0.80 wt. %, about 0.85 wt. %, about 0.90 wt. %, about 0.95 wt. %, about 1.0 wt. %, or within a range between any two such values. The doped activated carbon may be further characterized by the concentration of nitrogen provided by the nitrogen source on a dry carbon basis. In some embodiments, the concentration of nitrogen is about 5 wt. %, about 6 wt. %, about 7 wt. %, about 8 wt. %, about 9 wt. %, about 10 wt. %, about 11 wt. %, about 12 wt. %, or within a range between any two such values.

The doped activated carbon may be calcined after drying. In some embodiments, calcining is conducted at a temperature of about 750° C., about 800° C., about 850° ° C., about 900° C., about 950° C., about 1000° C., about 1050° C., about 1100° C., about 1150° C., about 1200° C., or within a range between any two such values. Calcination may, in some embodiments, be performed under an inert atmosphere such as nitrogen. Any of the previously described steps of washing, thermally treating, doping, and calcining, may be performed alone or in combination to form a sorbent material.

In some embodiments, the sorbent material of the present disclosure may be evaluated in terms of performance. In some embodiments, measuring the performance of the sorbent material may include measuring chloramine destruction number, or CDN, according to Calgon Carbon Test Method 39 (TM-39). In some embodiments, measuring the performance of the sorbent material may include peroxide destruction testing as measured by the peroxide number determined by Calgon Carbon Test Method 25 (TM-25). In some embodiments, measuring the performance of the sorbent material may include measuring both the chloramine destruction number and the peroxide number. In some embodiments, the CDN of the sorbent material may be about 10 to about 75, for example about 10, about 15, about 20, about 25, about 30, about 35, about 40, about 45, about 50, about 55, about 60, about 65, about 70, about 75, or any value or range between any two such values. In some embodiments, the peroxide number is about 1.5 minutes to about 40 minutes or 2 minutes to about 40 minutes, for example about 1.5 minutes, 2 minutes, about 5 minutes, about 10 minutes, about 15 minutes, about 20 minutes, about 25 minutes, about 30 minutes, about 35 minutes, about 40 minutes, or any value or range between any two such values. In some embodiments, the sorbent material has a modified contact pH of about 3 to about 11, for example about 3, about 4, about 5, about 6, about 7, about 8, about 9, about 10, about 11, or any value or range between any two such values. In some embodiments, the sorbent material has an oxygen content of about 3% to about 9%, for example about 3%, about 4%, about 5%, about 6%, about 7%, about 8%, about 9%, or any value or range in between any two such values. The oxygen content or concentration described in this paragraph and throughout the specification is measured by elemental analysis.

In some embodiments, the sorbent material may be a “dual-use” sorbent material, such that it is capable of removing volatile organic compounds while simultaneously removing one or more of chlorine, chloramine, chloroform, trihalomethanes, haloacetic acids, and peroxides. In some embodiments, the sorbent material may be capable of removing one or more of chlorine, chloramine, chloroform, trihalomethanes, haloacetic acids, peroxides, and volatile organic compounds from a water source.

### EXAMPLES

Two commercial coconut feedstocks were employed. The first was a commercially available 12×40 non-acid washed, coconut-based activated carbon (OLC), and the second was a commercially available 12×40 coconut-based activated carbon that has been acid washed (OLC-AW). In some instances, the OLC or OLC-AW feedstocks were thermally oxidized in air at 450° C. for 1 hour, using 1 liter of air per minute before doping with an aqucous metal salt/urea solution. Total metal loadings were about 0.25 wt. % to about 0.50 wt. % on a dry carbon basis, prior to calcination. The concentration of nitrogen provided by the urea on a dry carbon basis, prior to calcination, was about 9 wt. %. After the doping process, the samples were dried in air at temperatures of about 100° C. to about 150° C. for up to two hours and then calcined in nitrogen at 950° C. for one hour. The calcined samples were subsequently cooled in nitrogen before determining their chloramine destruction performance as measured by chloramine destruction number (CDN) testing via Calgon Carbon Test Method 39 (TM-39) or peroxide destruction testing as measured by the peroxide number via Calgon Carbon Test Method 25 (TM-25). Higher CDN numbers represent more aggressive, faster chloramine destruction while smaller peroxide numbers represent more aggressive, faster peroxide destruction. The TM-39 and TM-25 evaluations are volumetric in nature, meaning that consistent volumes of carbon are evaluated to avoid test result variation that might arise from differences in carbon density.

Table 1 demonstrates the improvement in chloramine destruction number (where higher values are desirable) and peroxide number (where lower values are desirable) when both acid washing and thermal oxidation pretreatments are employed. This effect is seen for all metal-nitrogen chemistries employed. When neither pretreatment was used, CDN values ranged from 3.6 to 5.2, and peroxide numbers ranged from 54.2 minutes to 97.8 minutes. Using only one pretreatment, either acid washing or thermal oxidation, modestly improved the range of CDN values from 4.2 to 14.5 and the range of peroxide numbers from 16.9 to 90.9. When both acid washing and thermal oxidation were used, the CDN range was 11.7 to 72.2, and the peroxide number range was 2.6 minutes to 23.5 minutes. Therefore, the best chloramine and peroxide destruction behavior occurs only when both acid washing and thermal oxidation are employed as pretreatment steps prior to metal salt/nitrogen doping and subsequent calcination. However, one notices a significant CDN value of 14.5 in Example 2 when the virgin activated carbon is only acid washed and impregnated with the copper-iron-nitrogen chemistry. For this chemistry, acid washing alone was sufficient to achieve intermediate CDN values.

TABLE 1
Effect of Acid Washing and Thermal Oxidation Pretreatments

| | | Is the | | | | |
|---|---|---|---|---|---|---|
| | | Carbon | Is the Carbon | Doping Chemistry | | |
| | | Feedstock | Feedstock | (applied after | | |
| | | Acid | Thermally | completing Step 1 | | Peroxide |
| | Carbon | Washed | Oxidized | and/or the Step 2 | | Number |
| Ex. | Feedstock | (Step 1)? | (Step 2)? | pretreatment) | CDN | (min) |
| 1 | OLC | No | No | Copper-Iron | 5.2 | 54.2 |
| | | | | (50:50)/Urea | | |
| 2 | OLC | No | Yes | Copper-Iron | 10.3 | 16.9 |
| | | | | (50:50)/Urea | | |
| 3 | OLC-AW | Yes | No | Copper-Iron | 14.5 | 18.2 |
| | | | | (50:50)/Urea | | |
| 4 | OLC-AW | Yes | Yes | Copper-Iron | 72.2 | 2.6 |
| | | | | (50:50)/Urea | | |
| 5 | OLC | No | No | Iron-Urea | 3.6 | 30.0 |
| 6 | OLC | No | Yes | Iron-Urea | 6.9 | 19.0 |
| 7 | OLC-AW | Yes | No | Iron-Urea | 7.9 | 18.5 |
| 8 | OLC-AW | Yes | Yes | Iron-Urea | 54.7 | 3.0 |
| 9 | OLC | No | No | Copper-Urea | 3.6 | 97.8 |
| 10 | OLC | No | Yes | Copper-Urea | 4.2 | 54.1 |
| 11 | OLC-AW | Yes | No | Copper-Urea | 6.7 | 90.9 |
| 12 | OLC-AW | Yes | Yes | Copper-Urea | 11.7 | 23.5 |

As shown in Table 2, the order in which the pretreatment steps are performed also affects the resulting CDN and peroxide number. Conducting the acid wash first, prior to thermal oxidation, is crucial to impart the excellent performance that is observed in these activated carbons. This importance of the pretreatment order is evident when comparing Ex. 13 vs. 14, where the CDN improved from 24.0 to 66.3 and the peroxide number decreased from 8.3 minutes to 3.7 minutes. When the acid washing step was carried out prior to thermal oxidation, similar improvements in CDN and decreases in peroxide number are evident when comparing Examples 15 and 16. Example 15 has a CDN value of 47.0 and a peroxide number of 3.3 minutes vs. that of Example 16 which only had a CDN value of 13.1 and a peroxide number of 19.7 minutes. Again, Examples 13, 15 and 17 benefit from performing the acid washing step prior to the thermal oxidation step and the benefit is observed for all metal-nitrogen doping chemistries. Throughout Table 2, the modified contact pH is lower for samples that were acid washed prior to thermal oxidation which suggests a more acidic activated carbon surface. The more acidic nature of these carbons translated to a more effective final product after doping and calcination as evident by the increase in CDN number and decrease in peroxide number. Modified contact pH was determined via Calgon Carbon Test Method 70 (TM-70) which is described herein.

### TM-70—Modified Contact pH

The following equipment and reagents were obtained prior to commencement of determination of modified contact pH.
pH meter (any model with temperature compensation capabilities)
Combination electrode (polymer or glass combination pH electrode with temperature compensation. The electrode must be of high quality and have a rapid response time. If the pH of the sample is expected to be >9 and a high Na⁺ ion concentration is present (Na₂SO₄ buffer), a special “high pH” electrode is recommended.)
Glass graduated cylinder (TD 100 mL)
Filter paper (pre-folded E&D Grade 513 or similar, 18.5 cm or similar)
Funnel (stemless Pyrex top i.d. 100 mm or similar)
Glass beaker (400 mL and 100 mL)
Glass volumetric flask (1 liter)
Magnetic stirrer and stir bar
Sodium sulfate (anhydrous, Na₂SO₄, formula weight 142.04)
Sulfate solution (80 ppm)
   Prepare a one Liter solution by adding 0.12 g of Na₂SO₄ to 800 mL of Type I Reagent Water in a clean volumetric flask. Shake to dissolve and dilute to the volume mark with the reagent water. The solution should have a pH of 6.0 q 0.5. If it does not, check the purity of the reagent water.
Type I reagent water
   Distilled deionized from a Mill-Q Plus water purification system or equivalent is preferred. (Refer to Standard Methods for the Examination of Water and Wastewater for definition).
Calibrating buffer solutions
   Commercially available pH 4, pH 7 and pH 10 buffer solutions for calibration of the pH meter under standard conditions. If pH>9, a pH 11 calibrating buffer solution is also recommended.

Modified contact pH was determined in accordance with the following procedure:

### A. Calibration

1. Because of the wide variety of pH meters and accessories, detailed operating procedures cannot be incorporated into this method. Always calibrate the pH meter prior to use; daily or at the start of each work shift is recommended as a minimum. Replace electrodes when they appear damaged or response times are slow.

2. Using the calibrating buffer solutions, calibrate the system at a minimum of two points that bracket the expected pH of the sample and are approximately three pH units or more apart. A pH 7 and pH 10 buffer is adequate for most carbon samples. If the product has a contact pH value estimated to be >9, use of a special “high pH” electrode is recommended. A pH 11 buffer should also be used to calibrate.

3. Place the calibrating buffer solution in a clean, dry 100 mL beaker using sufficient volume to cover the sensing elements of the electrodes. Gently stir and read the value after one minute. Read the pH. Repeat. If the pH value is the same, calibrate the meter. Adjust if necessary.

4. Repeat adjustments on successive portions of the two (low-high) calibrating buffer solutions until readings are within 0.1 pH units of the buffer solution values. Periodically measure the calibration buffers to assure that the meter calibration is maintained.

### B. Contact pH Determination

1. Weigh a representative portion of the granular activated carbon sample into a 400 mL beaker:

$$pH - Type Carbon ( wet carbon ) - 40. g \\ Standard Carbon ( dry carbon ) - 25. g$$

Do not dry the sample. The pH type carbon normally has a high moisture content. Small amounts of moisture normally associated (<2%) with standard carbon cause no problems.

2. Add 100 mL of the 80 ppm sulfate solution to the carbon sample. Confirm the pH of the sulfate solution prior to use. Prepare a fresh solution if the pH is not 6.0+/−0.5.

3. Add a magnetic stirring rod, and slowly stir the mixture for 30 minutes+/−1 minute. When stirring the mixture, avoid producing bubbles.

4. Filter the mixture by gravity through filter paper to remove the carbon fines. Collect the filtrate for determination of the pH. Carbon fines will adhere to the pH electrode and prevent accurate pH readings, eventually destroying the electrode.

5. Place the electrode in the filtrate solution, gently stir for about one minute and read the value. Stir again for about 30 seconds and again read the pH. If the value is almost the same (4 0.1) report this pH value as the “Modified” Contact pH. If the pH value increase after the second stirring this means that the response time of the electrode is slow. Continue stirring and reading until the pH value no longer increase. If more than an additional 30 seconds is needed, consider replacing the electrode. The porous glass tip is probably clogged with carbon fines.

TABLE 2
Effect of Order of Pretreatment Steps

| | | | | Pre- | | | |
|---|---|---|---|---|---|---|---|
| | | | | treated | | | |
| | | | | Carbon | | | |
| | | | | Modified | Subsequent | | Peroxide |
| | Carbon | Pretreatment | Pretreatment | Contact | Doping | | Number |
| Ex. | Feedstock | Step 1 | Step 2 | pH | Chemistry | CDN | (min) |
| 13 | OLC | Nitric Acid | Thermal | 5.7 | Copper-Iron | 66.3 | 3.7 |
| | | Wash | Oxidation | | (50:50)/ | | |
| | | | | | Urea | | |
| 14 | OLC | Thermal | Nitric Acid | 8.3 | Copper-Iron | 24.0 | 8.3 |
| | | Oxidation | Wash | | (50:50)/ | | |
| | | | | | Urea | | |
| 15 | OLC | Nitric Acid | Thermal | 5.7 | Iron-Urea | 47.2 | 3.3 |
| | | Wash | Oxidation | | | | |
| 16 | OLC | Thermal | Nitric Acid | 8.3 | Iron-Urea | 13.1 | 19.7 |
| | | Oxidation | Wash | | | | |
| 17 | OLC | Nitric Acid | Thermal | 5.7 | Copper- | 9.7 | 36.0 |
| | | Wash | Oxidation | | Urea | | |
| 18 | OLC | Thermal | Nitric Acid | 8.3 | Copper- | 7.0 | 37.7 |
| | | Oxidation | Wash | | Urea | | |

Table 3 shows the effect that acid or base washing, and subsequent thermal oxidation has on the activated carbon's modified contact pH prior to metal-nitrogen doping and calcination. The modified contact pH of the activated carbon is reduced to values below 7.0 by first washing in mineral acids (nitric, hydrochloric, or sulfuric acid) and then thermally oxidizing in air. After doping these activated carbons and calcining, some of the highest CDN values are realized as shown in Examples 19-21. It is important to note that the use of any one of these mineral acids in Examples 19-21 achieves similar modified contact pH values after thermal oxidation as they have similar modified contact pH values (˜5.7-6.2)

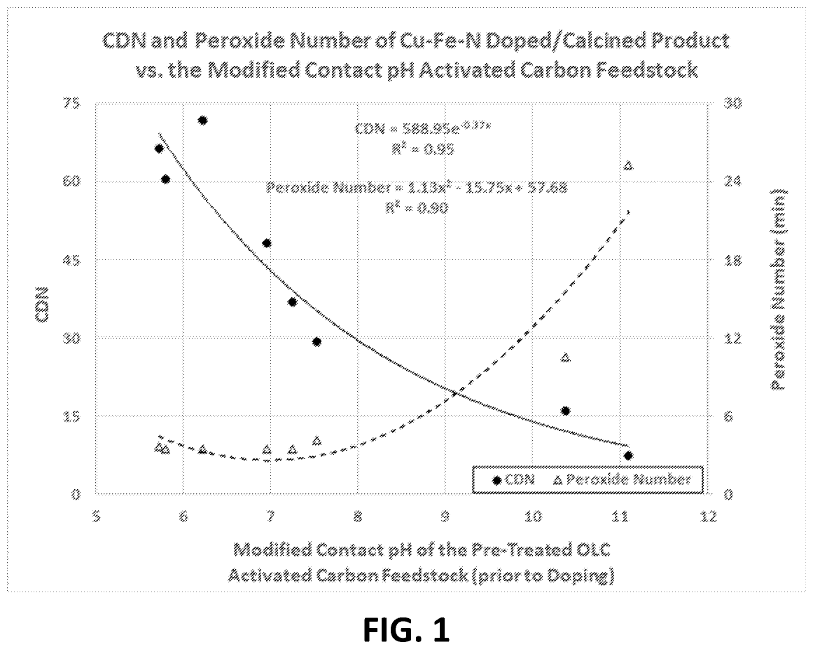

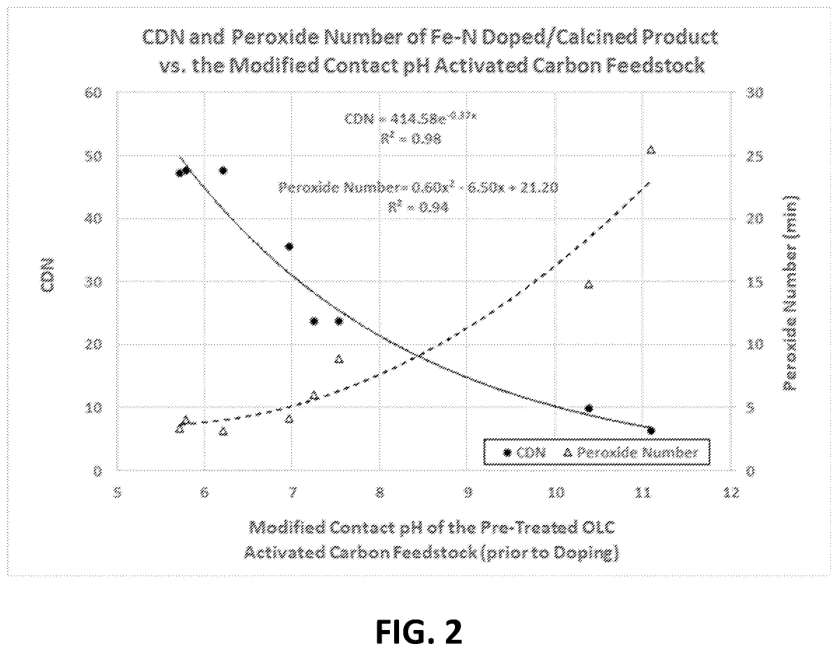

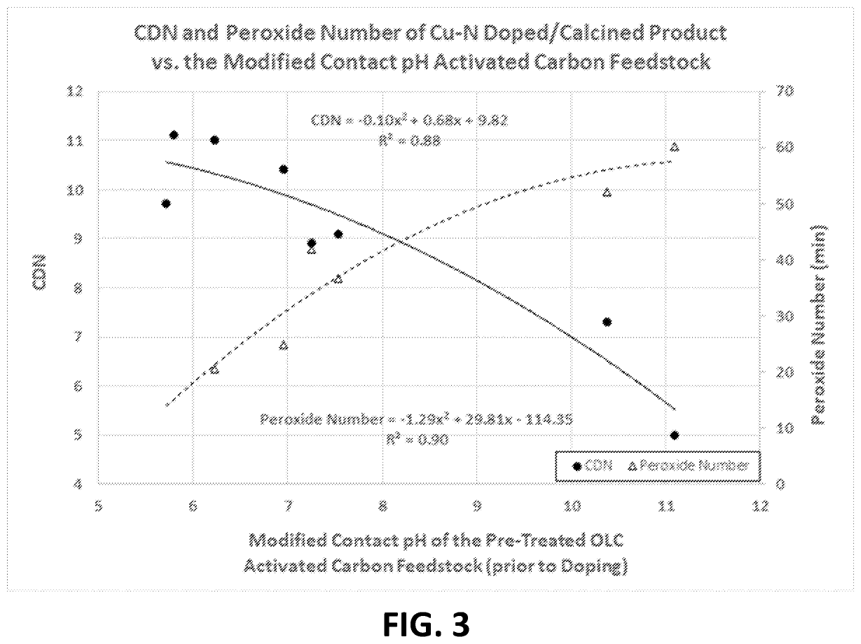

The general importance of acid washing, prior to thermal oxidation, is demonstrated further in Table 3 since improvements in CDN are observed whether one uses a known oxidizing acid like nitric acid (Example 21), a less oxidizing acid like sulfuric acid (Example 20), a non-oxidizing mineral acid like hydrochloric acid (Example 19), or weak acids like acetic acid (Example 22) or citric acid (Example 23). Improvements over the non-washed OLC (Example 26) precursor are seen even if bases like ammonium hydroxide (Example 24) or sodium hydroxide (Example 25) are used in the first pre-treatment step. This data indicates that the modification of the carbon surface using acid or base treatments in combination with thermal oxidation improves the chloramine performance of the final product. FIGS. 1-3 show the trend of increasing CDN and reduced peroxide number for each of the three doping chemistries, Cu—Fe—N, Fe—N, and Cu—N, respectively described in Table 3.

TABLE 3
Effect of Type of Acid or Base Wash and Metal
in Doping Solution (With Thermal Oxidation)

| | | Activated | | | | |
|---|---|---|---|---|---|---|
| | | Carbon | Modified | | | |
| | Carbon | Pretreatment | Contact | CDN | CDN | CDN |
| Ex. | Feedstock | Process | pH | Cu—Fe—N | Fe—N | Cu—N |
| 19 | OLC | Hydrochloric | 6.2 | 71.7 | 47.8 | 11.0 |
| | | Acid then | | | | |
| | | Thermal | | | | |
| | | Oxidation | | | | |
| 20 | OLC | Sulfuric Acid | 5.8 | 60.5 | 47.6 | 11.1 |
| | | then Thermal | | | | |
| | | Oxidation | | | | |
| 21 | OLC | Nitric Acid then | 5.7 | 66.3 | 47.2 | 9.7 |
| | | Thermal | | | | |
| | | Oxidation | | | | |
| 22 | OLC | Acetic Acid then | 7.0 | 48.1 | 35.5 | 10.4 |
| | | Thermal | | | | |
| | | Oxidation | | | | |
| 23 | OLC | Citric Acid then | 7.3 | 37.0 | 23.8 | 8.9 |
| | | Thermal | | | | |
| | | Oxidation | | | | |
| 24 | OLC | Ammonium | 7.5 | 29.2 | 23.8 | 9.1 |
| | | Hydroxide then | | | | |
| | | Thermal | | | | |
| | | Oxidation | | | | |
| 25 | OLC | Sodium | 10.4 | 16.1 | 9.9 | 7.3 |
| | | Hydroxide then | | | | |
| | | Thermal | | | | |
| | | Oxidation | | | | |
| 26 | OLC | Thermal | 11.1 | 7.5 | 6.3 | 5.0 |
| | | Oxidation Only | | | | |

Table 4 shows correlation between the modified contact pH of the pretreated OLC activated carbon and its bulk oxygen content as measured by elemental analysis. Generally, higher oxygen content is associated with lower modified contact pH. In turn, those pretreated activated carbons with the lower modified contact pH produce final products (after processing) with higher CDN values and lower peroxide numbers as shown in Table 3 and FIGS. 1-3. A highly oxygenated activated carbon feedstock that results from the washing/thermal oxidation pretreatments was found to be critical to achieving excellent performance, which is obtained by pretreatment first with acid wash, and then with thermal oxidation. One also notes that thermal oxidation alone (Example 33), without a preceding acid or base pretreatment step, results in an activated carbon with the highest modified contact pH and lowest oxygen concentration, and by extension, a lower CDN value, as shown in Table 3 (Example 26).

TABLE 4
Oxygen Content of the Activated Carbons

| | | Activated Carbon | Modified | % O as measured |
|---|---|---|---|---|
| | Carbon | Pretreatment | Contact | by Elemental |
| Ex. | Feedstock | Process | pH | Analysis |
| 27 | OLC | Hydrochloric Acid | 5.3 | 8.94 |
| | | then Thermal | | |
| | | Oxidation | | |
| 28 | OLC | Sulfuric Acid then | 6.4 | 7.62 |
| | | Thermal Oxidation | | |
| 29 | OLC | Nitric Acid then | 6.6 | 8.42 |
| | | Thermal Oxidation | | |
| 30 | OLC | Citric Acid then | 8.6 | 3.92 |
| | | Thermal Oxidation | | |
| 31 | OLC | Sodium Hydroxide | 10.3 | 3.79 |
| | | then Thermal | | |
| | | Oxidation | | |
| 32 | OLC | Ammonium | 11.0 | 3.81 |
| | | Hydroxide then | | |
| | | Thermal Oxidation | | |
| 33 | OLC | Thermal Oxidation | 11.7 | 2.91 |
| | | Only | | |

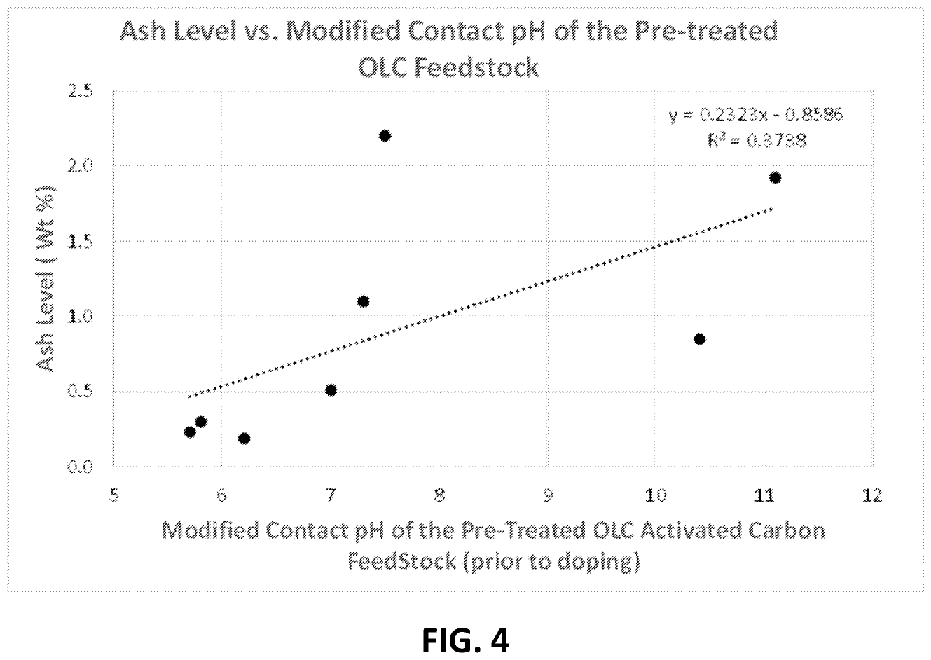

It was discovered that the modified contact pH was not well correlated with the ash level of the activated carbon, as shown in FIG. 4. Without wishing to be bound by theory, it is suspected that this rules out changes in ash content as being a contributing factor to enhanced chloramine and peroxide destruction.

Additionally, it was demonstrated that if one performs acid washing and thermal oxidation on a coconut carbon like OLC but does not include a metal species as part of the aqueous doping solution (e.g., including only a nitrogen source such as urea), the maximum CDN achieved was only 3.3 and peroxide values typically exceeded 60 minutes. The inclusion of a metal species in the doping solution is therefore critical to achieving high performance.

In Table 5, Examples 35-37 show that if the virgin OLC coconut activated carbon is simply acid washed, but not thermally oxidized, CDN improvements are still realized as compared to a coconut carbon that was not pretreated at all, like Example 34. Of the acid pretreatments, sulfuric acid provides the highest CDN values when no thermal oxidation is employed. Of the three metal-nitrogen chemistries used for doping, the copper-iron-nitrogen chemistry provides the best CDN response when the carbon is simply acid washed, however.

TABLE 5
Effect of Type of Acid Wash and Metal in Doping
Solution (Without Thermal Oxidation)

| | | Activated | | | | |
|---|---|---|---|---|---|---|
| | | Carbon | Modified | | | |
| | Carbon | Pretreatment | Contact | CDN | CDN | CDN |
| Ex. | Feedstock | Process | pH | Cu—Fe—N | Fe—N | Cu—N |
| 34 | OLC | None | 10.1 | 3.7 | 4.6 | 5.0 |
| 35 | OLC | Nitric Acid | 8.5 | 19.4 | 10.2 | 6.0 |
| | | Only | | | | |
| 36 | OLC | Hydrochloric | 7.3 | 15.8 | 9.9 | 6.7 |
| | | Acid Only | | | | |
| 37 | OLC | Sulfuric Acid | 2.9 | 21.4 | 15.9 | 7.1 |
| | | Only | | | | |

Additional testing was conducted to determine the performance of an activated carbon that is formed from a coal precursor (sometimes referred to as a “coal based” activated carbon) and which has been contacted with copper, iron, and nitrogen impregnants to improve chloramine destruction performance. The nitrogen impregnants include urea, for example. The additional testing also compared activated carbons that are formed from coconut precursors (sometimes referred to as “coconut based” activated carbon) to those activated carbons formed from coal precursors.

Still further testing was performed to determine whether impregnating coal based activated carbon or coconut based activated carbon with a zinc-iron-nitrogen chemistry would be beneficial.

Accordingly, Table 6 describes the CDN performance of Filtrasorb® 400 (also known in industry as F400), which is a coal based activated carbon available from Calgon Carbon Corp. of Moon Township, Pennsylvania, USA. F400 is manufactured from bituminuous coal which is pulverized and reagglomerated during the manufacturing process. F400 has a minimum iodine number of 1000 mg/g and typically has an apparent density of approximately 0.54 g/cm³.

One other purpose of Table 6 is to demonstrate the difference of performance of the coal based activated carbons as a function of the processing that has been performed prior to calcination. As shown in Table 6, Comparative Example 38 shows the baseline performance of F400 which has not been processed in any way. Comparative Example 39 shows that the CDN performance almost doubles when the F400 is thermally oxidized but where no other treatment is performed. Examples 40-44 demonstrate significant increases in measured CDN especially when the coal based activated carbon is acid washed, thermally oxidized, and doped with the 50:50 copper:iron solution and urea. It should be noted that Comparative Examples 38 and 39 are prepared and measured according to columns 11-12 and Table 1 of U.S. Pat. No. 10,702,853, the entirety of which is incorporated reference herein.

TABLE 6
Coal Based Activated Carbon CDN (Pre-Calcination Processing)

| | | | | Doping | |
|---|---|---|---|---|---|
| | | Is | | Chemistry | |
| | | Carbon | Is Carbon | (must | |
| | | Feedstock | Feedstock | complete Step | |
| | Activated | Acid | Thermally | 1 and/or the | |
| | Carbon | Washed? | Oxidized | Step 2 | |
| Ex. | Feedstock | (Step 1) | (Step 2) | Pretreatment) | CDN |
| Comp. | F400 | No | No | None | 1.4 |
| Ex. 38 | | | | | |
| Comp. | F400 | No | Yes | None | 2.2 |
| Ex. 39 | | | | | |
| 40 | F400 | No | No | Copper-Iron | 5.5 |
| | | | | (50:50)/Urea | |
| 41 | F400 | Yes | No | Copper-Iron | 9.6 |
| | | | | (50:50)/Urea | |
| 42 | F400 | No | Yes | Copper-Iron | 24.3 |
| | | | | (50:50)/Urea | |
| 43 | F400 | Yes | Yes | Copper-Iron | 46.4 |
| | | | | (50:50)/Urea | |
| 44 | F400 | Yes | Yes | Urea Only | 19.6 |

Of the Examples shown in Table 6, Example 43 exhibits the highest CDN with a value of 46.4. Like the coconut activated carbon Examples described in Table 1, the best chloramine performance (that is, the highest CDN) results from a process methodology in which the F400 activated carbon feedstock is treated as follows: first, the F400 is acid washed; second, the F400 is thermally oxidized, third, the F400 is doped by contacting the F400 with the metal-nitrogen mixtures is first subjected to acid-washing and thermal oxidization steps, before metal-nitrogen doping and the final calcination step. Additionally, this data shows excellent CDN performance can be achieved using coal-based activated carbon when employing the copper-iron-nitrogen chemistry. When comparing Example 43 with Example 44, it also highlights the importance of the metal dopants that are contacted to the surface of the activated carbon when that step is combined with the steps of acid washing and thermal oxidation pretreatments to achieve the highest CDN values. If only urea is contacted to the surface of the activated carbon in order to dop the activated carbon, as shown in Example 44, and even if the acid-wash and thermal oxidation pretreatments are employed, only modest improvements in the CDN performance can be achieved. Again, as shown in Table 6, the production steps of Example 44 where only urea was contacted resulted in a CDN of 19.6, compared with a CDN of 46.4 for Example 43 where copper and iron were added to the urea solution.

The Examples above describe the treatment of coconut or coal based activated carbon with various precursors including copper, iron, and nitrogen (for example, urea) precursors in order to enhance the ability of the activated carbon to remove chrloramine from a fluid stream. The activated carbon was additionally tested as follows to determine the potential benefits of a dopant chemistry that includes zinc, iron, and urea. In Examples 45-50, the activated carbon feedstock was impregnated with zinc and iron to achieve a total metal loading of about 0.50 wt. %, on a pre-calcined, dry carbon basis. Of this total metal loading, about 50 wt. % was zinc and about 50% was iron. Urea was added to the carbon to achieve a loading of about 17 wt. %, on a pre-calcined, dry carbon basis. All Examples were calcined in a nitrogen atmosphere at 950° C. for upwards of 60 minutes. In Table 7, Examples 48 and 50 again show that acid washing and thermal oxidation pretreatments of the activated carbon feedstock prior to aqueous impregnation and calcination produce very high CDN values of 34.6 for the coal-based F400 product, or 71.2 for the coconut-based OLC-AW product.

Examples 49 and 50 were additionally tested for the “peroxide destruction number,” sometimes referred to as the “peroxide number.” The “peroxide destruction number” which is also referred to as the “peroxide number” is also measured. The peroxide number is a volumetric test, which means that performance is measured and normalized to a specified volume of sorbent material. The test for the peroxide number is well known in the art, and is described by U.S. Pat. No. 5,470,748, which is incorporated by reference herein in its entirety.

During the test of the peroxide number, the sorbent material is first pulverized to a fine mesh size fraction where at least 90 wt. %, and in certain tests at least 95 wt. %, of the sorbent material will pass through a 325 mesh U.S. Standard Series sieve (44 μm opening size). A specified amount of the pulverized sorbent material is placed in a vacuum flask (Dewar), and 100 mL of deionized water is added to the vacuum flask. The addition of deionized water is performed such that any pulverized sorbent material clinging to the sides of the vacuum flask is carried into the main body of water at the bottom of the vacuum flask. Next, a 50 mL aliquot of aqueous buffer solution is added to the vacuum flask. The aqueous buffer solution is 0.5 molar in K₂HPO₄ and 0.5 molar in KH₂PO₄. After the aqueous buffer solution is added, a magnetic stir bar is added into the vacuum flask and energized to begin stirring. Stirring speed is increased until a vortex greater than about 0.5 inches (1.27 cm) deep is formed in the mixture and the optimum stir bar speed is achieved. The optimum stir bar speed is selected so that additional increases in stir bar speed do not significantly affect the peroxide decomposition time.

As described in the previous paragraph, during the test of the peroxide number, a specified amount of sorbent material is added to a buffered hydrogen peroxide solution. Because the test is a volumetric test, the specified amount of sorbent material that is added to the buffered hydrogen peroxide solution is based on one half (½) of the apparent density of the sorbent material. In particular, the mass of sorbent material in grams that is added to the solution is equal to one half (½) of the measured apparent density of the sorbent material, when the apparent density of the sorbent material is reported in g/cm³. In the buffered solution, the catalytic properties of the sorbent material cause the peroxide to be catalyzed and thereby destroyed (i.e., the hydrogen peroxide decomposes into water and oxygen gas).

The catalysis of hydrogen peroxide is exothermic. Thus, the rated of decomposition by way of the sorbent material can be approximated over time by measuring the temperature of the buffered solution. As used herein, the “peroxide number” is the length of time in minutes that is required for the buffered solution containing the sorbent material sample to reach 75% of the recorded maximum temperature. Faster times and therefore smaller values of the peroxide number indicate more catalytic activity and thus a higher performance sorbent material. In some embodiments, the peroxide destruction number measured in minutes is about 1.5, about 2.0, about 2.5, about 3.0, about 3.5, about 4.0, about 4.5, about 5.0, about 5.5, about 6.0, about 6.5, about 7.0, or any range that is formed from two or more of the above values as endpoints of the range. In some embodiments, the peroxide destruction number measured in minutes is about 10, about 15, about 20, about 25, about 30, about 35, about 40, about 45, or any range that is formed from two or more of the above values as endpoints of the range.

The peroxide number is related to and has some correlation with the CDN in that each are measures of the catalytic activity of the sorbent material. However, the correlation is not always exact, because each represents a different aspect of the catalytic activity of a sorbent material. Still further, the catalytic activity is useful only for those compounds that are catalyzed, but other compounds must be adsorbed to be effectively removed from a fluid stream. A superior sorbent material would therefore in addition to possessing a high CDN would ideally also possess a low peroxide number (measured in minutes), as well as performing on adsorption tests so that it is effective at removing a broad range of compounds from fluid streams.

Returning to the data of Table 7, Example 50 also shows that very low peroxide numbers of about 2.3 minutes are possible. This data suggests that the doping of activated carbon with zinc-iron-nitrogen results in activated carbon products with excellent chloramine performance that is equal to or better than similarly impregnated copper-iron-nitrogen activated carbons.

TABLE 7
CDN Performance of Zinc-Iron-Urea Impregnated F400 and OLC-AW Activated
Carbon As a Function of Pre-Calcination Processing Differences

| | | Is the | | Doping | | |
|---|---|---|---|---|---|---|
| | | Carbon | Is the Carbon | Chemistry | | |
| | | Feedstock | Feedstock | (applied after | | |
| | Activated | Acid | Thermally | completing Step 1 | | Peroxide |
| | Carbon | Washed | Oxidized | and/or the Step 2 | | Number |
| Ex. | Feedstock | (Step 1) | (Step 2) | Pretreatment) | CDN | (min) |
| 45 | F400 | No | No | Zinc-Iron | 5.1 | — |
| | | | | (50:50)/Urea | | |
| 46 | F400 | Yes | No | Zinc-Iron | 6.1 | — |
| | | | | (50:50)/Urea | | |
| 47 | F400 | No | Yes | Zinc-Iron | 15.2 | — |
| | | | | (50:50)/Urea | | |
| 48 | F400 | Yes | Yes | Zinc-Iron | 34.6 | — |
| | | | | (50:50)/Urea | | |
| 49 | OLC-AW | Yes | No | Zinc-Iron | 14.5 | 8.7 |
| | | | | (50:50)/Urea | | |
| 50 | OLC-AW | Yes | Yes | Zinc-Iron | 71.2 | 2.3 |
| | | | | (50:50)/Urea | | |

Certain beneficial embodiments of the disclosure are listed below:

Clause 1. A sorbent material, comprising: a carbonaceous material which has been activated to form a precursor activated carbon, wherein the precursor activated carbon has been subjected to a pretreatment with an acid or a base followed by optional thermal oxidation, and wherein the precursor activated carbon has been contacted with a nitrogen source and a metal source and comprises about 5% to about 12% nitrogen as measured on a dry precursor activated carbon basis and about 0.1 wt. % to about 1.0 wt. % metal as measured on a dry precursor activated carbon basis.

Clause 2. The sorbent material of clause 1, wherein the sorbent material has a modified contact pH of about 3 to about 11.

Clause 3. The sorbent material of clause 1, wherein the pretreatment is with an acid.

Clause 4. The sorbent material of clause 3, wherein the acid is any of nitric acid, sulfuric acid, hydrochloric acid, hydrobromic acid, hydroiodic acid, phosphoric acid, acetic acid, citric acid, ascorbic acid, or combinations thereof.

Clause 5. The sorbent material of clause 3, wherein the sorbent material has a modified contact pH of about 5 to about 8.

Clause 6. The sorbent material of clause 1, wherein the pretreatment is with a base.

Clause 7. The sorbent material of clause 6, wherein the base is any of sodium hydroxide, ammonium hydroxide, magnesium hydroxide, potassium hydroxide, calcium hydroxide, ammonia, sodium carbonate, sodium bicarbonate, or combinations thereof.

Clause 8. The sorbent material of clause 6, wherein the sorbent material has a modified contact pH of about 7 to about 11.

Clause 9. The sorbent material of clause 1, wherein the metal is selected from iron, copper, or combinations thereof.

Clause 10. The sorbent material of clause 1, wherein the carbonaceous material is formed from one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

Clause 11. The sorbent material of clause 1, wherein the carbonaceous material is formed from coconut shell.

Clause 12. The sorbent material of clause 1, wherein the sorbent material has a chloramine destruction number (CDN) of about 10 to about 75.

Clause 13. The sorbent material of clause 1, wherein the sorbent material has a chloramine destruction number (CDN) of about 37 to about 72.

Clause 14. The sorbent material of clause 1, wherein the sorbent material has a peroxide number of about 2 minutes to about 40 minutes.

Clause 15. The sorbent material of clause 1, wherein the sorbent material has a peroxide number of about 2.6 minutes to about 3.7 minutes.

Clause 16. The sorbent material of clause 1, wherein the sorbent material has an oxygen content of about 3% to about 9%.

Clause 17. A method for making a sorbent material, comprising steps of: providing a carbonaceous material, activating the carbonaceous material to form a precursor activated carbon, pretreating the precursor activated carbon with an acid or a base, optionally thermally oxidizing the precursor activated carbon at a temperature of about 450° C., contacting the precursor activated carbon with a metal source and a nitrogen source to form a doped precursor activated carbon, and calcining the doped precursor activated carbon at a temperature of about 950° C.

Clause 18. The method of clause 17, wherein the carbonaceous material is formed from one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

Clause 19. The method of clause 17, wherein the carbonaceous material is coconut shell.

Clause 20. The method of clause 17, wherein the acid is any of nitric acid, sulfuric acid, hydrochloric acid, hydrobromic acid, hydroiodic acid, phosphoric acid, acetic acid, citric acid, ascorbic acid, or combinations thereof.

Clause 21. The method of clause 17, wherein the base is any of ammonium hydroxide, sodium hydroxide, magnesium hydroxide, potassium hydroxide, calcium hydroxide, ammonia, sodium carbonate, sodium bicarbonate, or combinations thereof.

Clause 22. The method of clause 17, wherein the metal source is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, hydrates thereof, or combinations thereof.

Clause 23. The method of clause 17, wherein the nitrogen source has an oxidation state of −3.

Clause 24. The method of clause 17, wherein the nitrogen source comprises urea, dicyandiamide, melamine, or combinations thereof.

Clause 25. The method of clause 17, wherein the sorbent material has a modified contact pH of about 5 to about 11.

Clause 26. The method of clause 17, wherein the sorbent material has a chloramine destruction number (CDN) of about 10 to about 75.

Clause 27. The sorbent material of clause 17, wherein the sorbent material has a chloramine destruction number (CDN) of about 37 to about 72.

Clause 28. The method of clause 17, wherein the sorbent material has a peroxide number of about 2 minutes to about 40 minutes.

Clause 29. The method of clause 17, wherein the sorbent material has a peroxide number of about 2.6 minutes to about 3.7 minutes.

Clause 30. The method of clause 17, wherein the sorbent material has an oxygen of about 3% to about 9%.

Clause 31. A method for treating water that potentially contains chlorine, chloramine, chloroform, trihalomethanes, haloacetic acids, peroxides, volatile organic compounds, or combinations thereof, comprising steps of: contacting the water with a sorbent material which comprises an activated carbon formed from a carbonaceous material and wherein the activated carbon has been pretreated with an acid or a base and subsequent thermal oxidation, followed by doping with a metal source and a nitrogen source, wherein contacting the water with sorbent material results in removal of one or more of chlorine, chloramine, chloroform, trihalomethanes, haloacetic acids, peroxides, and volatile organic compounds.

Clause 32. The method of clause 31, wherein the carbonaceous material is coconut shell.

Clause 33. The method of clause 31, wherein the metal source is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, hydrates thereof, or combinations thereof.

Clause 34. The method of clause 31, wherein the nitrogen source has an oxidation state of −3.

Clause 35. The method of clause 31, wherein the nitrogen source comprises urea, dicyandiamide, melamine, or combinations thereof.

Clause 36. The method of clause 31, wherein the sorbent material has a modified contact pH of about 3 to about 11.

Clause 37. The method of clause 31, wherein the sorbent material has a chloramine destruction number (CDN) of about 10 to about 75.

Clause 38. The method of clause 31, wherein the sorbent material has a chloramine destruction number (CDN) of about 37 to about 72.

Clause 39. The method of clause 31, wherein the sorbent material has a peroxide number of about 2 minutes to about 40 minutes.

Clause 40. The method of clause 31, wherein the sorbent material has a peroxide number of about 2.6 minutes to about 3.7 minutes.

Clause 41. The method of clause 31, wherein the sorbent material has an oxygen content of about 3% to about 9%.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A sorbent material, comprising:
a carbonaceous material which has been activated to form a precursor activated carbon,
wherein the precursor activated carbon has been subjected to a pretreatment with an acid or a base followed by optional thermal oxidation, and
wherein the precursor activated carbon has been contacted with a nitrogen source and a metal source and comprises about 5% to about 12% nitrogen as measured on a dry precursor activated carbon basis and about 0.1 wt. % to about 1.0 wt. % metal as measured on a dry precursor activated carbon basis.

2. The sorbent material of claim 1, wherein the sorbent material has a modified contact pH of about 3 to about 11.

3. The sorbent material of claim 1, wherein the pretreatment is with an acid.

4. The sorbent material of claim 3, wherein the acid is any of nitric acid, sulfuric acid, hydrochloric acid, hydrobromic acid, hydroiodic acid, phosphoric acid, acetic acid, citric acid, ascorbic acid, or combinations thereof.

5. The sorbent material of claim 3, wherein the sorbent material has a modified contact pH of about 5 to about 8.

6. The sorbent material of claim 1, wherein the pretreatment is with a base.

7. The sorbent material of claim 6, wherein the base is any of sodium hydroxide, ammonium hydroxide, magnesium hydroxide, potassium hydroxide, calcium hydroxide, ammonia, sodium carbonate, sodium bicarbonate, or combinations thereof.

8. The sorbent material of claim 6, wherein the sorbent material has a modified contact pH of about 7 to about 11.

9. The sorbent material of claim 1, wherein the metal is selected from iron, copper, zinc, or combinations thereof.

10. The sorbent material of claim 1, wherein the carbonaceous material is formed from one or more of coconut shell, bituminous coal, sub-bituminous coal, lignite coal, or anthracite coal.

11. The sorbent material of claim 1, wherein the sorbent material has a chloramine destruction number (CDN) of about 10 to about 75.

12. The sorbent material of claim 1, wherein the sorbent material has a chloramine destruction number (CDN) of about 37 to about 72.

13. The sorbent material of claim 1, wherein the sorbent material has a peroxide number of about 1.5 minutes to about 40 minutes.

14. The sorbent material of claim 1, wherein the sorbent material has a peroxide number of about 2.6 minutes to about 3.7 minutes.

15. The sorbent material of claim 1, wherein the sorbent material has an oxygen content of about 3% to about 9%.

16. A method for making a sorbent material, comprising steps of:
providing a carbonaceous material,
activating the carbonaceous material to form a precursor activated carbon,
pretreating the precursor activated carbon with an acid or a base,
optionally thermally oxidizing the precursor activated carbon at a temperature of about 450° C.,
contacting the precursor activated carbon with a metal source and a nitrogen source to form a doped precursor activated carbon, and
calcining the doped precursor activated carbon at a temperature of about 950° C.

17. The method of claim 16, wherein the carbonaceous material is formed from one or more of coconut shell, bituminous coal, sub-bituminous coal, lignite coal, or anthracite coal.

18. The method of claim 16, wherein the acid is any of nitric acid, sulfuric acid, hydrochloric acid, hydrobromic acid, hydroiodic acid, phosphoric acid, acetic acid, citric acid, ascorbic acid, or combinations thereof.

19. The method of claim 16, wherein the base is any of ammonium hydroxide, sodium hydroxide, magnesium hydroxide, potassium hydroxide, calcium hydroxide, ammonia, sodium carbonate, sodium bicarbonate, or combinations thereof.

20. The method of claim 16, wherein the metal source is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, zinc chloride, zinc nitrate, zinc sulfate, zinc acetate, hydrates thereof, or combinations thereof.

21. The method of claim 16, wherein the nitrogen source has an oxidation state of −3.

22. The method of claim 16, wherein the nitrogen source comprises urea, dicyandiamide, melamine, or combinations thereof.

23. The method of claim 16, wherein the sorbent material has a modified contact pH of about 5 to about 11.

24. The method of claim 16, wherein the sorbent material has a chloramine destruction number (CDN) of about 10 to about 75.

25. The sorbent material of claim 16, wherein the sorbent material has a chloramine destruction number (CDN) of about 37 to about 72.

26. The method of claim 16, wherein the sorbent material has a peroxide number of about 1.5 minutes to about 40 minutes.

27. The method of claim 16, wherein the sorbent material has a peroxide number of about 2.6 minutes to about 3.7 minutes.

28. The method of claim 16, wherein the sorbent material has an oxygen of about 3% to about 9%.

29. A method for treating water that potentially contains chlorine, chloramine, chloroform, trihalomethanes, haloacetic acids, peroxides, volatile organic compounds, or combinations thereof, comprising steps of:
contacting the water with a sorbent material which comprises an activated carbon formed from a carbonaceous material and wherein the activated carbon has been pretreated with an acid or a base and subsequent thermal oxidation, followed by doping with a metal source and a nitrogen source,
wherein contacting the water with sorbent material results in removal of one or more of chlorine, chloramine, chloroform, trihalomethanes, haloacetic acids, peroxides, and volatile organic compounds.

30. The method of claim 29, wherein the carbonaceous material is one or more of bituminous coal, sub-bituminous coal, lignite coal, anthracite coal, or coconut shell.

31. The method of claim 29, wherein the metal source is any of copper (II) sulfate pentahydrate, copper (II) chloride, copper (II) nitrate, copper (II) acetate, copper (II) carbonate hydroxide, copper (II) formate, copper (II) formate tetrahydrate, iron (II) chloride, iron (III) chloride, zinc chloride, zinc nitrate, zinc sulfate, zinc acetate, hydrates thereof, or combinations thereof.

32. The method of claim 29, wherein the nitrogen source has an oxidation state of −3.

33. The method of claim 29, wherein the nitrogen source comprises urea, dicyandiamide, melamine, or combinations thereof.

34. The method of claim 29, wherein the sorbent material has a modified contact pH of about 3 to about 11.

35. The method of claim 29, wherein the sorbent material has a chloramine destruction number (CDN) of about 10 to about 75.

36. The method of claim 29, wherein the sorbent material has a chloramine destruction number (CDN) of about 37 to about 72.

37. The method of claim 29, wherein the sorbent material has a peroxide number of about 1.5 minutes to about 40 minutes.

38. The method of claim 29, wherein the sorbent material has a peroxide number of about 2.6 minutes to about 3.7 minutes.

39. The method of claim 29, wherein the sorbent material has an oxygen content of about 3% to about 9%.
